(19) United States
(12) Patent Application Publication
(10) Pub. No.: US 2005/0199115 A1
(43) Pub. Date: Sep. 15, 2005

(54) Manual food slicer

(76) Inventors: Loren J. Veltrop, Deerfield, IL (US); Robert C. Long, Glenview, IL (US); Michael M. Maciejewski, St. Charles, IL (US)

Correspondence Address: John R. Hoffman, 616 W. 13th Street, P.O. Box 191, Jasper, IN, 47547, US

(21) Appl. No.: 10/799,539

(22) Filed: Mar. 13, 2004

(51) Int. Cl. B26D 1/30

(52) U.S. Cl. 83/599; 83/607

(57) ABSTRACT

A manually-operated apparatus is provided for slicing a food product. The apparatus includes a base for supporting the apparatus on an appropriate support surface. An anvil is disposed on top of the base and includes a support surface on which the food product is positioned. A cutting head has a plurality of cutting blades for cutting the food product. A common pivot shaft pivotally mounts both the anvil and the cutting head to the base. The cutting head is mounted for pivotal movement between an elevated position allowing the food product to be positioned on the anvil and a lowered cutting position whereat the cutting blades have sliced through the food product and into slots in the anvil. The anvil is mounted for pivotal movement between a generally horizontal food-supporting position and an elevated cleaning position allowing food products to be cleaned off of the base.

### FIELD OF THE INVENTION

This invention relates to a manually-operated apparatus for cutting or slicing food products.

### BACKGROUND OF THE INVENTION

Food cutting or slicing apparatus have been known, literally, for decades. Various prior art apparatus have been designed for slicing, dicing, serrating and otherwise cutting food products, such as meats, fruits, vegetables and other foodstuffs and even such diverse food products as mush. Such prior art apparatus utilize knife or blade members which have been sharpened into single cutting edges. Some apparatus use cutting wires.

Manually-operated food slicing apparatus are to be distinguished from mechanized slicing apparatus which typically include a power-rotated slicing blade or disk. A manually-operated slicing apparatus includes some form of base or anvil on top of which the food product is positioned. A carriage or cutting head is movably mounted on the base, such as by a pivotal mount, to move cutting knives, blades or wires on the carriage or cutting head into engagement with and through the food product.

One of the problems with typical food slicing apparatus is that the slicing operations most often create food particles which accumulate in and around the various components of the apparatus. Since manually-operated food slicing apparatus typically are unduly complicated, this accumulation of food particles is extremely difficult to get rid of or swept away from the apparatus without literally lifting the apparatus and shaking it bodily which, in turn, creates a further mess of food particles. The present invention is directed to solving these problems by providing a manually-operated slicing apparatus wherein various components not only are movably mounted for slicing functions but also are movably mounted for cleaning purposes without totally dismantling the entire apparatus. On the other hand, the apparatus of the invention also is extremely easy to be dismantled for complete cleaning or washing purposes.

It should be understood that the term “slicing” is used herein and in the claims hereof in a generic sense to not only include operations such as “slicing” food products but also dicing, cubing, blocking, serrating and otherwise cutting the food products.

### SUMMARY OF THE INVENTION

An object, therefore, of the invention is to provide a new and improved manually-operated food slicing apparatus of the character described.

In the exemplary embodiment of the invention, the manually-operated food slicing apparatus includes a base for supporting the apparatus on an appropriate support surface. A slotted anvil is disposed on top of the base and includes a generally planar slotted surface on which the food product is positioned. First pivot means are provided for pivotally mounting the slotted anvil on the base for pivotal movement between a generally horizontal food-supporting position and an elevated cleaning position allowing food particles to be cleaned off of the base. A cutting head has a plurality of generally parallel cutting blades for cutting the food product. Second pivot means are provided for pivotally mounting the cutting head on the base for pivotal movement between an elevated position allowing the food product to be positioned on the slotted anvil and a lowered cutting position whereat the cutting blades have sliced through the food product and into the slots in the anvil.

As disclosed herein, the base is generally flat and includes a generally planar top surface. The slotted support surface of the slotted anvil is generally parallel to the top surface of the base.

The slotted anvil is a one-piece structure stamped and formed of sheet metal material and includes generally horizontal feet portions at opposite ends of the slotted support surface for engaging the base. Generally vertical pedestal portions join the feet portions to opposite ends of a slotted plate portion forming the slotted support surface.

The cutting head is a cast metal frame having a central opening spanned by a plurality of generally parallel, laterally spaced cutting blades aligned with a plurality of slots in the anvil. The cutting blades have rounded cutting edges to prevent the blades from cutting an operator's fingers. Opposite ends of the cutting blades are press-fit into grooves in the cast metal frame in taut condition.

According to one aspect of the invention, the first pivot means include a readily removable pivot shaft to provide for easy dismantling of the slotted anvil from the base for cleaning purposes. Preferably, the second pivot means also include a readily removable pivot shaft to provide for easy dismantling of the cutting head from the base for cleaning purposes. A unique feature of the invention is that the first pivot means and the second pivot means are provided by a common pivot shaft. The slotted anvil, thereby, is disposed for pivotal movement beneath the pivotal movement of the cutting head.

According to another aspect of the invention, the common pivot shaft comprises an elongated pivot pin having a manually graspable proximal end. A distal end of the common pivot shaft is press-fit into a pivot opening in the base to allow for ready removal of the pivot pin and dismantling the slotted anvil and the cutting head from the base for cleaning purposes.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of the manually-operated food slicing apparatus of the invention, with the cutting head in its lowered cutting position;

FIG. 2 is an end elevational view of the apparatus, looking toward the left-hand end of FIG. 1;

FIG. 3 is an end elevational view, looking toward the right-hand end of FIG. 1;

FIG. 4 is an exploded perspective view illustrating the components of the apparatus;

FIG. 5 is a top plan view of the apparatus;

FIG. 6 is a bottom plan view of the apparatus;

FIG. 7 is a side elevational view of the apparatus, looking at the rear side as viewed in FIG. 1;

FIG. 8 is a perspective view similar to that of FIG. 1, with the cutting head in its elevated, inoperative position;

FIG. 9 is a view similar to that of FIG. 7, with the cutting head in its elevated, inoperative position;

FIG. 10 is a perspective view similar to that of FIG. 1, with the slotted anvil elevated for cleaning purposes; and

FIG. 11 is a view similar to that of FIG. 9, but with the slotted anvil in the position of FIG. 10.

### DETAILED DESCRIPTION OF THE PREFERRED EMBODIMENT

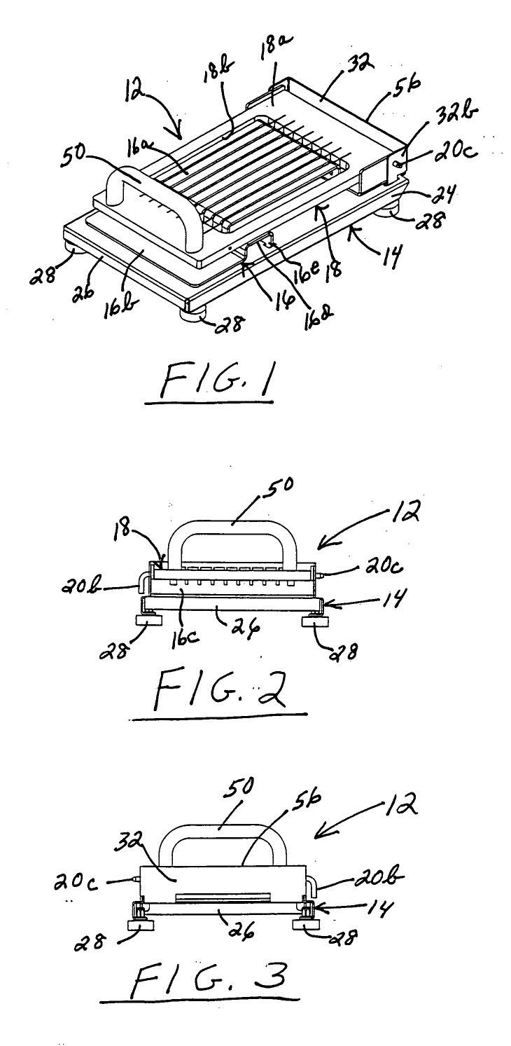

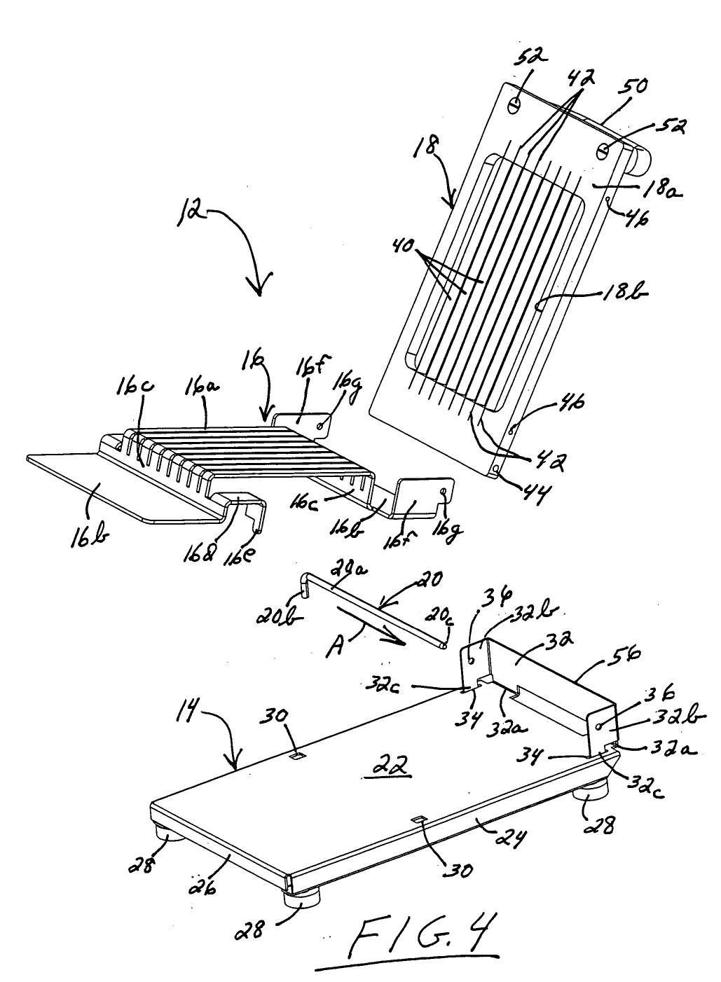

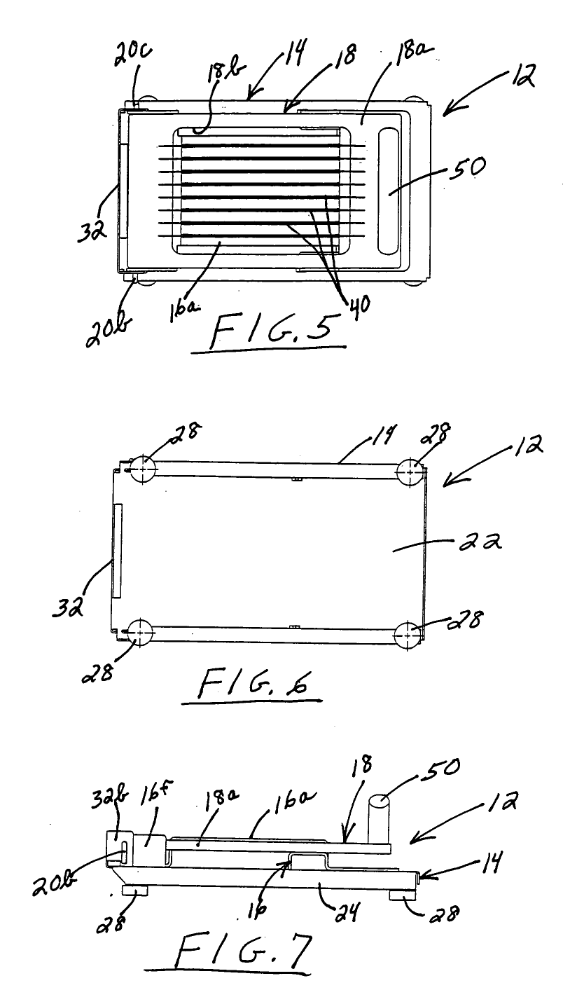

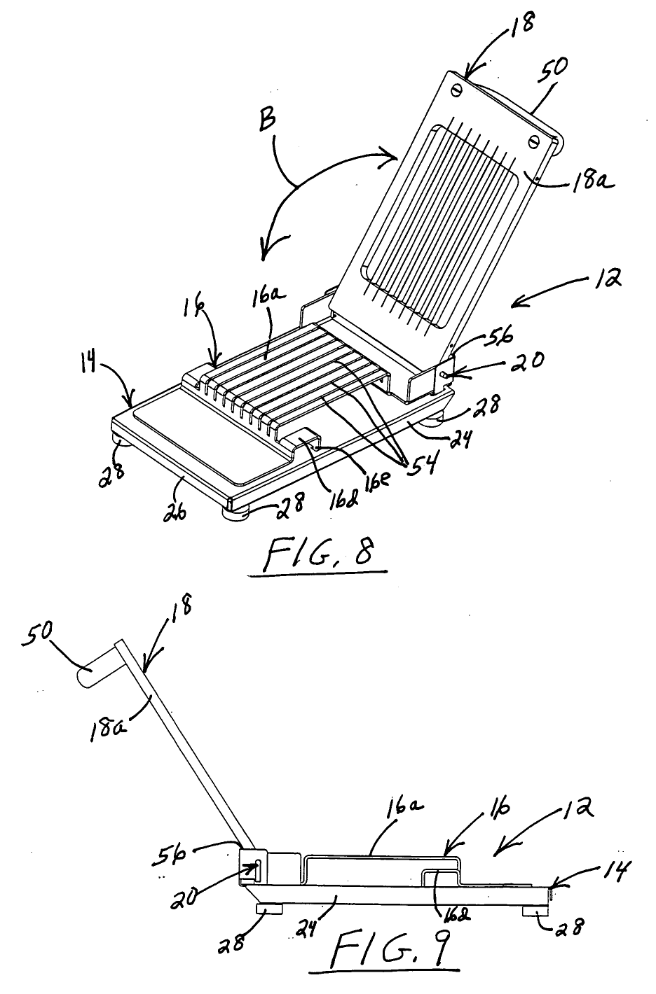

Referring to the drawings in greater detail, and first to FIGS. 1-7, the invention is embodied in a manually-operated apparatus, generally designated 12, for slicing a food product. As pointed out in the “Background”, above, the term “slicing” herein and in the claims hereof is used in a generic sense to include not only slicing of the food product, but also dicing, cubing, blocking, serrating or other such cutting operations. In addition, although food slicing apparatus 10 has particular utility in slicing a specific food product, the novel concepts of facilitating the operation and cleaning of the apparatus are equally applicable for slicing a wide variety of foodstuffs. The specific food product with which slicing apparatus 12 has significant utility is in the slicing of a cooked chicken filet, particularly a cooked chicken filet which has been breaded and deep fried, whereby any cutting operations on the breaded and fried product creates considerable particles which accumulate around the slicing apparatus, such as particles of the crust which is adhered to the chicken meat. However, as stated, the unique cleaning capabilities of slicing apparatus 12 are equally applicable for slicing other foodstuffs.

With that understanding, and as best seen in FIG. 4, slicing apparatus 10 includes four major components, namely: a base, generally designated 14; a slotted anvil, generally designated 16, positioned on top of the base as best seen in FIG. 8; a cutting head, generally designated 18; and a common pivot shaft, generally designated 20, which provides for common pivotal mounting of both slotted anvil 16 and cutting head 18.

Base 14 of slicing apparatus 12 may be stamped and formed of sheet metal material so that the base is generally flat and includes a generally planar top surface 22. A pair of side flanges 24 are formed or bent downwardly along opposite side edges of top surface 22, and a front end flange 26 is formed or bent downwardly along the front edge of top surface 22. Flanges 24 and 26 rigidify the top surface. Four rubber-like feet 28 are secured to the bottom four corners of base 14, beneath top surface 22, for supporting the apparatus on an appropriate support surface, such as a counter top, with some cushioning affect. A pair of holes 30 are stamped in top surface 22 generally intermediate the front and rear ends thereof adjacent the sides thereof, for purposes to be described hereinafter. Finally, a rear flange 32 is formed or bent, as at 32a, upwardly from the rear edge of top surface 22. A pair of side flanges 32b extend forward from opposite ends of rear flange 32, and a pair of legs 32c are inserted into a pair of slots 34 stamped into top surface 22 of the base. A pivot hole 36 is formed in each side flange 32b.

Slotted anvil 16 of slicing apparatus 12 also may be stamped and formed of sheet metal material. The slotted anvil includes a slotted support surface 16a which is positioned above and generally parallel to top surface 22 by means of a pair of generally horizontal feet portions 16b at opposite ends of the slotted support surface and a pair of generally vertical pedestal portions or flanges 16c which join feet portions 16b to opposite ends of a slotted plate portion 16a which forms slotted support surface 16a. A pair of generally L-shaped legs 16d have feet 16e which are positionable into holes 30 in top surface 22 of base 14. A pair of pivot flanges 16f are bent upwardly from opposite sides of rear foot portion 16b, and a pivot hole 16g is formed in each pivot flange 16f.

Cutting head 18 of slicing apparatus 12 is provided by a generally rectangular cast metal frame 18a which is flat or planar and which is provided with a rectangular central opening 18b. A plurality of generally parallel, laterally spaced cutting blades 40 have opposite ends which are press-fit into grooves 42 formed in cast metal frame 18a. The cutting blades have rounded or dull cutting edges to prevent the blades from cutting an operator's fingers. Frame 18a may be cast of an aluminum alloy, for instance, and a pivot bore 44 is cast or drilled entirely through an inner end of the frame. A pair of locking pins 46 also may extend entirely through the frame and through opposite ends of cutting blades 40 to lock the blades in slots 42 in the frame, in a taut condition. Lastly, a generally U-shaped handle 50 is fixed to the outer end of cutting head 18, as by a pair of bolts 52 (FIG. 4).

Pivot shaft 20 is provided by an elongated, stainless steel pivot pin 20a which is L-shaped to define a manually graspable handle 20b at a proximal end of the pin. A distal end 20c of the pivot pin is chamfered or beveled to be somewhat pointed.

In assembly of slicing apparatus 12, slotted anvil 16 first is positioned on top of top surface 22 of base 14 by positioning feet 16e (FIG. 4) of the anvil into holes 30 in top surface 22 of the base. This will align pivot holes 16g in pivot flanges 16f of the slotted anvil with pivot holes 36 in side flanges 32b of the base. Cutting head 18 then is positioned to align pivot bore 44 with pivot holes 16g of the slotted anvil and pivot holes 36 of the base. Pin 20a of pivot shaft 20 then is inserted in the direction of arrow “A” (FIG. 4) first through pivot hole 36 in the left-hand side flange 32b of the base as viewed in FIG. 4. Distal end 20c of pin 20a of the pivot shaft then is moved through pivot hole 16g of the left-hand pivot flange 16f of the slotted anvil and entirely through pivot bore 44 of cutting head 18. The pivot shaft continues to move seriatim through pivot hole 16g of the right-hand pivot flange 16f of the slotted anvil and finally into pivot hole 36 of the right-hand side flange 32b of the base. Preferably, at least pivot hole 36 of the right-hand pivot flange 32b of the base is sized to receive distal end 20c with an interference or press-fit so that the pivot shaft does not fall out of the apparatus when fully assembled. The other pivot holes in slotted anvil 16 and base 14, along with pivot bore 44 of cutting head 18, may be slightly larger to allow for free insertion of the pivot shaft, but the holes and bore should not be too large to allow for any significant relative movement or “rattling” between the components.

In operation, cutting head 18 can pivot about pivot shaft 20 in the direction of double-headed arrow “B” (FIG. 8) between an elevated position shown in FIG. 8 allowing the food product to be positioned on slotted support surface 16a of slotted anvil 16, and a lowered cutting position shown in FIG. 1 whereat cutting blades 40 of the cutting head have sliced through the food product and into a plurality of slots 54 in the slotted anvil. When cutting head 18 is in its elevated position as shown in FIG. 8, the cutting head is “over center” of a vertical plane through pivot shaft 20, and frame 18a of the cutting head rests on a top edge 56 of rear flange 32 (FIG. 4) of the base.

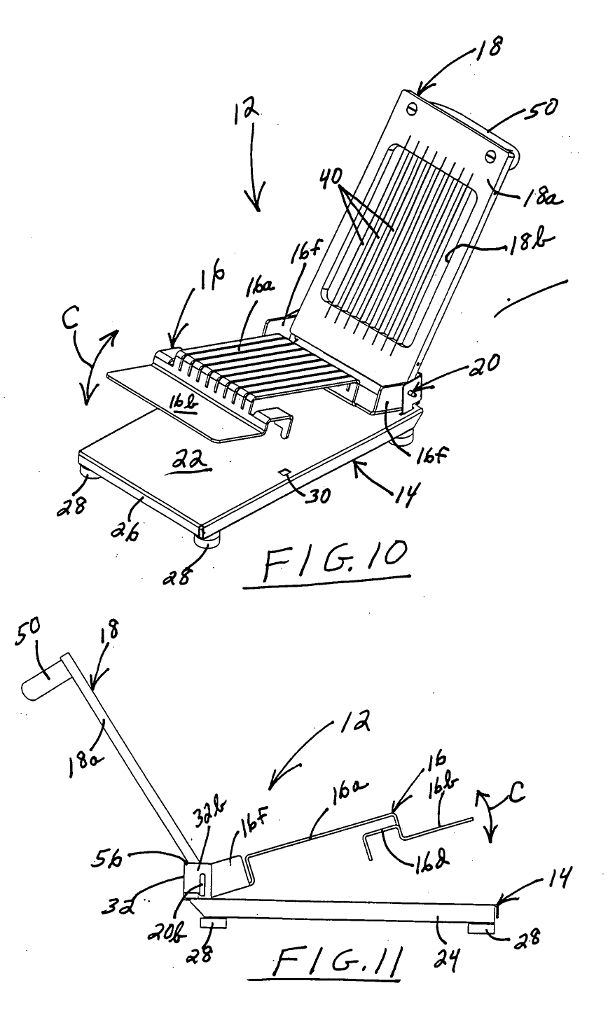

As seen in FIGS. 10 and 11, slotted anvil 16 also is pivotable about pivot shaft 20 in the direction of double-headed arrow “C” between a generally horizontal food-supporting position shown in FIGS. 1-9 and an elevated position shown in FIGS. 10 and 11 which allows food particles, such as crust particles from a breaded/cooked chicken filet, to be cleaned off of top surface 22 of base 14, i.e., from beneath the slotted anvil. Breaded cooked food products have a tendency to create considerable residue when cut. By providing an assembly wherein both cutting head 18 and slotted anvil 16 are pivotable about a common pivot shaft 20, the number of parts of the assembly is considerably reduced, and the manufacture, assembly and use of slicing apparatus 12 is efficient and cost effective.

Lastly, when it is desired to completely wash or clean all of the components of slicing apparatus 12, pivot shaft 20 simply is pulled back out of the assembly, opposite arrow “A” in FIG. 4, and the four components of slicing apparatus easily are cleaned or washed and reassembled in cleaned condition in a very efficient and simple operation. The removal of the single pivot shaft releases all of the components in one simultaneous process.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A manually-operated apparatus for slicing a food product, comprising:
a base for supporting the apparatus on an appropriate support surface;
a slotted anvil disposed on top of the base and including a slotted support surface on which the food product is positioned;
first pivot means pivotally mounting the slotted anvil on the base for pivotal movement between a generally horizontal food-supporting position and an elevated cleaning position allowing food particles to be cleaned off of the base;
a cutting head having a plurality of cutting blades for cutting the food product; and
second pivot means pivotally mounting the cutting head on the base for pivotal movement between an elevated position allowing the food product to be positioned on the slotted anvil and a lowered cutting position whereat the cutting blades have sliced through the food product and into slots in the anvil.

2. The apparatus of claim 1 wherein said base is generally flat and includes a generally planar top surface.

3. The apparatus of claim 2 wherein the slotted support surface of said slotted anvil is generally parallel to the top surface of the base.

4. The apparatus of claim 1 wherein said slotted anvil includes pedestal means for engaging the base and elevating the slotted support surface of the anvil above the base.

5. The apparatus of claim 4 wherein said slotted anvil is a one-piece structure stamped and formed of sheet metal material and includes generally horizontal feet portions at opposite ends of the slotted support surface for engaging the base and generally vertical pedestal portions joining the feet portions to opposite ends of a slotted plate portion forming said slotted support surface.

6. The apparatus of claim 1 wherein said cutting head comprises a cast metal frame having a central opening spanned by a plurality of generally parallel, laterally spaced cutting blades aligned with a plurality of slots in the anvil.

7. The apparatus of claim 6 wherein said cutting blades have rounded cutting edges to prevent the blades from cutting an operator's fingers.

8. The apparatus of claim 6 wherein opposite ends of said cutting blades are press-fit into grooves in the cast metal frame.

9. The apparatus of claim 1 wherein said first pivot means include a readily removable pivot shaft to provide for easy dismantling of the slotted anvil from the base for cleaning purposes.

10. The apparatus of claim 1 wherein said second pivot means include a readily removable pivot shaft to provide for easy dismantling of the cutting head from the base for cleaning purposes.

11. The apparatus of claim 1 wherein both said first and second pivot means include readily removable pivot shaft means to provide for easy dismantling of the slotted anvil and the cutting head from the base for cleaning purposes.

12. The apparatus of claim 1 wherein both said first and second pivot means include a common pivot shaft for both the slotted anvil and the cutting head.

13. The apparatus of claim 12 wherein said common pivot shaft comprises an elongated pivot pin having a manually graspable proximal end and a distal end press fit into a pivot opening in the base to allow for ready removal of the pivot pin and dismantling the slotted anvil and the cutting head from the base for cleaning purposes.

14. The apparatus of claim 1 wherein said first and second pivot means include a pivot portion which is common to both pivot means.

15. The apparatus of claim 14 wherein said slotted anvil is disposed for pivotal movement beneath the pivotal movement of the cutting head.

16. A manually-operated apparatus for slicing a food product, comprising:
a generally flat base for supporting the apparatus on an appropriate support surface and including a generally planar top surface;
a slotted anvil disposed on top of the base and including a slotted support surface on which the food product is positioned, the anvil including pedestal means for engaging the base and elevating the slotted support surface above and generally parallel to the top surface of the base;
first pivot means pivotally mounting the slotted anvil on the base for pivotal movement between a generally horizontal food-supporting position and an elevated cleaning position allowing food particles to be cleaned off of the base;
a cutting head having a case metal frame with a central opening spanned by a plurality of generally parallel, laterally spaced cutting blades aligned with a plurality of slots in the slotted support surface of the anvil; and
second pivot means pivotally mounting the cutting head on the base for pivotal movement between an elevated position allowing the food product to be positioned on the slotted anvil and a lowered cutting position whereat the cutting blades have sliced through the food product and into slots in the anvil.

17. The apparatus of claim 16 wherein said slotted anvil is a one-piece structure stamped and formed of sheet metal material and includes generally horizontal feet portions at opposite ends of the slotted support surface for engaging the base and generally vertical pedestal portions joining the feet portions to opposite ends of a slotted plate portion forming said slotted support surface.

18. The apparatus of claim 16 wherein said cutting blades have rounded cutting edges to prevent the blades from cutting an operator's fingers.

19. The apparatus of claim 18 wherein opposite ends of said cutting blades are press-fit into grooves in the cast metal frame.

20. The apparatus of claim 16 wherein said first pivot means include a readily removable pivot shaft to provide for easy dismantling of the slotted anvil from the base for cleaning purposes.

21. The apparatus of claim 16 wherein said second pivot means include a readily removable pivot shaft to provide for easy dismantling of the cutting head from the base for cleaning purposes.

22. The apparatus of claim 16 wherein both said first and second pivot means include a common pivot shaft for both the slotted anvil and the cutting head.

23. The apparatus of claim 22 wherein said common pivot shaft comprises an elongated pivot pin having a manually graspable proximal end and a distal end press fit into a pivot opening in the base to allow for ready removal of the pivot pin and dismantling the slotted anvil and the cutting head from the base for cleaning purposes.

24. The apparatus of claim 16 wherein said first and second pivot means include a pivot portion which is common to both pivot means.

25. The apparatus of claim 24 wherein said slotted anvil is disposed for pivotal movement beneath the pivotal movement of the cutting head.

26. A manually-operated apparatus for slicing a food product, comprising:
a base for supporting the apparatus on an appropriate support surface;
an anvil disposed on top of the base and including a support surface on which the food product is positioned;
a cutting head having a plurality of cutting blades for cutting the food product; and
a common pivot means for pivotally mounting both the anvil and the cutting head on the base, whereby the cutting head is mounted for pivotal movement between an elevated position allowing the food product to be positioned on the anvil and a lowered cutting position whereat the cutting blades have sliced through the food product, and the anvil is mounted for pivotal movement between a generally horizontal food-supporting position and an elevated cleaning position allowing food products to be cleaned off of the base.

27. The apparatus of claim 26 wherein said base is generally flat and includes a generally planar top surface.

28. The apparatus of claim 27 wherein the support surface of the anvil is generally flat and generally parallel to the top surface of the base.

29. The apparatus of claim 26 wherein said anvil includes pedestal means for engaging the base and elevating the support surface of the anvil above the base.

30. The apparatus of claim 26 wherein said cutting head comprises a cast metal frame having a central opening spanned by a plurality of generally parallel, laterally spaced cutting blades aligned with a plurality of slots in the anvil.

31. The apparatus of claim 26 wherein said first pivot means include a readily removable pivot shaft to provide for easy dismantling of the anvil from the base for cleaning purposes.

32. The apparatus of claim 26 wherein said common pivot means comprises an elongated pivot pin having a manually graspable proximal end and a distal end press fit into a pivot opening in the base to allow for ready removal of the pivot pin and dismantling the anvil and the cutting head from the base for cleaning purposes.

33. The apparatus of claim 26 wherein said slotted anvil is disposed for pivotal movement beneath the pivotal movement of the cutting head.
